(19) United States
(12) Patent Application Publication
(10) Pub. No.: US 2013/0020880 A1
(43) Pub. Date: Jan. 24, 2013

(54) Energy Storage Circuit

(71) Applicants: Kengo ASAI, Hachioji (JP); Atsushi Isobe, Kodaira (JP); Kenichi Osada, Tokyo (JP); Yasushi Goto, Kokubunji (JP); Hideaki Takano, Kokubunji (JP)

(72) Inventors: Kengo ASAI, Hachioji (JP); Atsushi Isobe, Kodaira (JP); Kenichi Osada, Tokyo (JP); Yasushi Goto, Kokubunji (JP); Hideaki Takano, Kokubunji (JP)

(73) Assignee: Hitachi, Ltd., Tokyo (JP)

(21) Appl. No.: 13/541,827

(22) Filed: Jul. 5, 2012

(30) Foreign Application Priority Data
Jul. 22, 2011 (JP) 2011-160442

(51) Int. Cl. H02M 3/06

(52) U.S. Cl. 307/109

(57) ABSTRACT

An energy storage circuit includes a first capacitor connected with a power generating element via a first diode and a second capacitor connected with the power generating element via a second diode and a switch. The conduction state of the switch is controlled using the potential difference between its second and third electrodes (driving voltage V). The driving voltage when the switch enters its conductive state is higher than the driving voltage when the switch enters its non-conductive state.

### CLAIM OF PRIORITY

The present application claims priority from Japanese patent application JP 2011-160442 filed on Jul. 22, 2011, the content of which is hereby incorporated by reference into this application.

### FIELD OF THE INVENTION

The present invention relates to energy storage circuits, and more specifically to an energy storage circuit including a power generating element for converting energy in living space, such as vibration or heat, into electric energy.

### BACKGROUND OF THE INVENTION

Research and development of a sensor network including a large number of sensing modules are in progress. Such a sensing module needs not only to have a wireless communication function but also to operate without battery replacement. In order to enable a sensing module to operate without battery replacement, the sensing module needs to include a power generating element, such as a solar cell or an MEMS power generator, for converting energy in living space, such as vibration or heat, into electric energy.

Furthermore, such a sensing module should have a small footprint. To this end, the power generating element also needs to have a small size. A small-sized power generating element inevitably can generate only a small amount of electric power, thus requiring an energy storage circuit that can store the generated power efficiently and can supply it to the subsequent stage circuit in an efficient manner.

Such a technology is disclosed in Japanese Unexamined Patent Application Publication No 2009-219266, which specifically discloses an energy storage circuit for supplying electric power received from a micro power generator to the subsequent stage circuit by using a plurality of capacitors and a field detection switch. More specifically, of electrodes included in the current path of the field detection switch 12, the micro power generator side electrode (first electrode) is connected with a first capacitor 15 and the subsequent stage circuit side electrode (second electrode) is connected with a second capacitor 16. As a result, when a predetermined amount of electric charge is accumulated in the first capacitor thus resulting in the potential thereof reaching V2, the field detection switch 12 turns on so that the charge stored in the first capacitor is transferred to the second capacitor. Thereafter, when the potential of the first capacitor 15 decreases and reaches V1, the field detection switch turns off so that the charge storage operation in the first capacitor 15 is resumed. The patent reference describes that with such a configuration, a small amount of current available from a micro power generator, such as an MEMS power generator, can be used to supply power in a stable manner to a subsequent stage circuit that requires a relatively large amount of power.

### SUMMARY OF THE INVENTION

However, the invention disclosed in the patent reference has problems described blow. That is, as described above, when the field detection switch 12 turns on, the charge stored in the first capacitor is transferred to the second capacitor because the first and second capacitors are connected in the current path of the field detection switch 12. This makes the energy storage operation in the first capacitor unstable, and as a result, the charge available for the transfer to the second capacitor also becomes unstable. Furthermore, as this makes it difficult to use the first capacitor as a power source, it is also difficult to construct a power supply system having two power sources, i.e., both the first capacitor and the second capacitor.

An object of the present invention is to solve the above problems, and more specifically to enable electric energy to be stored in a more stable manner in an energy storage circuit including a power generating element and to enable a stable power supply system having two or more power sources to be constructed.

To briefly summarize a representative aspect of the invention disclosed herein, an energy storage device includes a power generating element, a first diode connected with the power generating element, a first capacitor connected with the first diode, a second diode connected with the power generating element, and a selection element. The selection element has a first electrode connected with the second diode, a second electrode connected with the second capacitor, and a third electrode connected with the first capacitor for controlling the conduction state between the first and second electrodes, and the potential difference between the second and third electrodes when the first and second electrodes transition from a non-conductive state to a conductive state is higher than the potential difference between the second and third electrodes when the first and second electrodes transition from the conductive state to the non-conductive state.

According to another aspect, an energy storage device includes a power generating element, a first diode connected with the power generating element, a first capacitor connected with the first diode, a second diode connected with the power generating element, and a selection element. The selection element has a first electrode connected with the second diode, a second electrode connected with the second capacitor, a third electrode connected with the first capacitor for controlling the conduction state between the first and second electrodes, and a fourth electrode connected to the ground potential, and the potential difference between the third and fourth electrodes when the first and second electrodes transition from a non-conductive state to a conductive state is higher than the potential difference between the third and fourth electrodes when the first and second electrodes transition from the conductive state to the non-conductive state.

The present invention enables electric energy to be stored in a more stable manner in an energy storage circuit including a power generating element, and further enables a stable power supply system having two or more power sources to be constructed.

### BRIEF DESCRIPTION OF THE DRAWINGS

FIG. 1 shows the configuration of an energy storage circuit;

FIG. 2 shows the configuration of a sensing module;

FIGS. 3A and 3B show the configurations of three-terminal MEMS switches;

FIGS. 4A and 4B show the operating mechanism of an MEMS switch;

FIG. 5 shows an exemplary dependency of an MEMS switch upon the applied voltage;

FIG. 6 shows the configuration of a four-terminal MEMS switch; and

FIGS. 7A, 7B, and 7C show the configuration of another four-terminal MEMS switch.

### DETAILED DESCRIPTION OF THE PREFERRED EMBODIMENTS

### First Embodiment

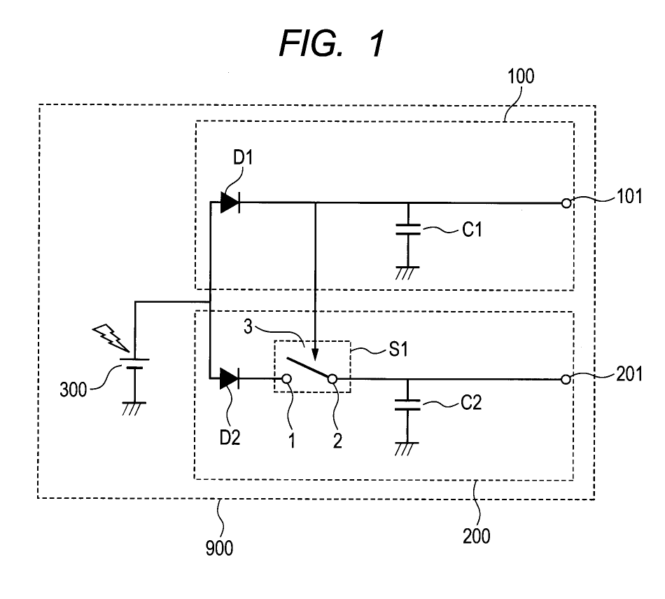

FIG. 1 shows an energy storage circuit 900 according to a first embodiment. As shown FIG. 1, the energy storage circuit 900 includes a first circuit 100, a second circuit 200, and a power generating element 300.

The first circuit 100 includes a first diode D1 connected with the power generating element 300, a first capacitor C1 connected with the first diode D1, and a first output terminal 101 connected with the first capacitor C1. The second circuit 200 includes a second diode D2 connected with the power generating element 300, a selection element S1 connected with the second diode D2, a second capacitor C2 connected with the selection element S1, and a second output terminal 201 connected with the second capacitor C2; the second circuit 200 is connected to the power generating element 300 in parallel with the first circuit 100.

The selection element S1 has a first electrode 1 connected with the second diode D2, a second electrode 2 connected with the second capacitor C2, and a third electrode 3 connected with the first capacitor C1. The third electrode 3 serves as a driving electrode for controlling the conduction state between the first electrode 1 and the second electrode 2.

The power generating element 300 is an element, such as a solar cell or an MEMS power generator, for converting energy in living space, such as vibration or heat, into electric energy. Using such an element enables the energy storage circuit 900 to operate without battery replacement.

The first diode D1 and the second diode D2 each have the anode connected with the power generating element 300 and the cathode connected to the corresponding capacitor (either the first capacitor or the second capacitor). Although electric charge generated in the power generating element is supplied to both the first diode D1 and the second diode D2, the charge is initially stored only in the first capacitor C1 because the selection element S1 is in a turned-off state in the initial state.

First, consider the case in which the amount of charge stored in the first capacitor C1 is low and, therefore, the potential difference between the second electrode 2 and the third electrode 3 (this potential difference is referred to as a “driving voltage V” in the present embodiment), which serve as the driving electrodes in the selection element S1, is less than the pull-in voltage Von of the selection element S1. In this case, the selection element S1 remains in the turned-off state, thus resulting in no current flowing into the second capacitor C2. This enables the first capacitor C1 to exclusively store the charge supplied from the power generating element 300. As a result, it is possible to activate a circuit with less power consumption, such as a clock circuit, soon through the first output terminal 101 connected with the first capacitor C1. Furthermore, the first diode D1 and the second diode D2 also serve to prevent backflow of charge, e.g., backflow of the charge supplied by the power generating element 300 and stored in the first capacitor C1 to the second capacitor C2. In this manner, the potentials applied by the capacitors to the first output terminal 101 and the second output terminal 201 respectively are stabilized, thus enabling a stable power supply system having two power sources to be constructed.

Then, as the flow of the charge from the power generating element 300 to the first capacitor C1 is continued, the potential difference between the second electrode 2 and the third electrode 3 increases, and when it reaches the pull-in voltage Von, the first electrode 1 and the second electrode 2 come into contact with each other, resulting in the electrodes transitioning to a conductive state. As a result, the selection element S1 turns on, enabling current to flow between the first electrode 1 and the second electrode 2. This allows a portion of the charge supplied from the power generating element 300 to be stored in the second capacitor C2.

Thereafter, as the charge stored in the first capacitor C1 is consumed by the circuit connected through the output terminal 101, the driving voltage V decreases, and when it reaches the pull-out voltage Voff of the selection element S1, the first electrode 1 and the second electrode 2 transition to a non-contact state, i.e., a non-conductive state because the potential difference between the second electrode 2 and the third electrode 3 is insufficient. As a result, the selection element S1 turns off, thus halting the charge storage operation in the second capacitor C2. In this manner, starting and halting the charge storage operation in the second capacitor C2 can be achieved.

Here, the selection element S1 is characterized in that the potential difference between the second electrode 2 and the third electrode 3 when the first electrode 1 and the second electrode 2 transition from the non-conductive state to the conductive state is higher than the potential difference between the second electrode 2 and the third electrode 3 when the first electrode 1 and the second electrode 2 transition from the conductive state to the non-conductive state, i.e., the pull-in voltage Von is higher than the pull-out voltage Voff. Having such a hysteresis property enables a length of time required to store a sufficient amount of charge in the second capacitor C2 to be secured in a stable manner.

That is, if the pull-in voltage Von of the selection element S1 were equal to the pull-out voltage Voff thereof, the selection element S1 would turn off immediately after it turns on. This is because the driving voltage V decreases gradually as the charge in the first capacitor C1 is consumed by the circuit connected through the first output terminal 101. Imparting the above described hysteresis property to the selection element S1 enables the selection element S1 to remain in the turned-on state until the driving voltage V reaches Voff although the charge in the first capacitor is consumed. As a result, a length of time required to store a sufficient amount of charge in the second capacitor C2 can be secured.

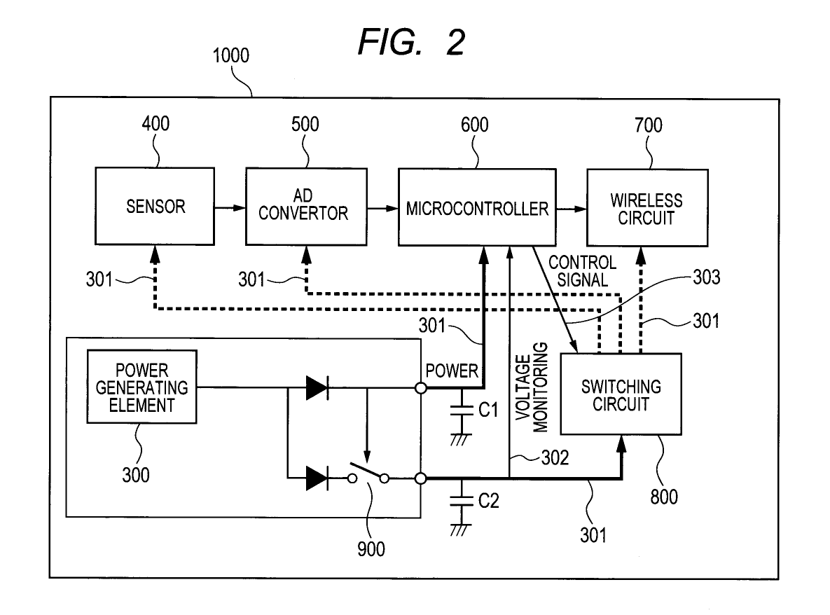

FIG. 2 shows a configuration in which the energy storage circuit 900 according to the present embodiment is applied to a sensing module 1000. The sensing module 1000 senses data at predetermined intervals, processes the data, and outputs it to the outside through a wireless circuit 700. In the present embodiment, the circuitry connected with the first terminal 101 includes a microcontroller 600, while the circuitry connected with the second terminal 201 includes a sensor 400, an AD convertor 500, a wireless circuit 700, and a switching circuit 800. Although the circuitry connectable with the terminals are not limited to these circuits, it is preferable that the circuitry connected with the first terminal 101 consume less power than the circuitry connected with the second terminal due to reasons described above. The operation of the module will now be described in detail.

Because the selection element S1 is initially in the turned-off state, all the charge generated by the power generating element 300 is supplied only to the first capacitor C1. Since the first capacitor C1 has a small capacitance, the charge storage operation is completed quickly. This charge is used to activate the microcontroller 600 connected with the first terminal 101 in a power saving mode (in which only the clock and timer circuitry is operated). Then, as the potential of the first capacitor C1 increases, the driving voltage V of the selection element S1 increases, and when it reaches the pull-on voltage Von, the selection element S1 turns on. As a result, the charge storage operation in the second capacitor C2 is started (capacitance C2>>capacitance C1).

The amount of charge stored in the first capacitor C1 decreases due to both the outflow resulting from the power consumed by the microcontroller 600 operating in the power saving mode and an decrease in the inflow from the power generating element 300. For this reason, the driving voltage V starts to decrease, and when it reaches the pull-out voltage Voff, the selection element S1 turns off. Then, because all the charge generated in the power generating element 300 is again exclusively directed toward and stored in the first capacitor C1, the driving voltage V starts to increase after hitting its lower limit, i.e., the pull-out voltage Voff. Thereafter, once the charge storage operation in the first capacitor C1 is completed, the selection element S1 turns on again, thus resulting in the charge storage operation in the second capacitor C2 being resumed.

In this manner, as long as the operating voltage of the microcontroller 600 is equal to or more than the pull-out voltage Voff and an amount of power equal to or more than the power consumed by the microcontroller 600 operating in the power saving mode is available from the power generating element 300, the operation of the microcontroller 600 can be continued constantly irrespective of the state of the energy storage circuit.

Then, the following operation is performed at predetermined intervals using the timer circuit included in the microcontroller 600. That is, when the inter-terminal voltage of the second capacitor C2 is in excess of a predetermined voltage (i.e., when a sufficient amount of charge is stored in the second capacitor C2), the microcontroller 600 switches from the power saving mode to a normal power mode, and controls the switching circuit 800 connected with the second capacitor C2 to supply sufficient power to the sensor 400, the AD convertor 500, and the wireless circuit 700 for a sufficient length of time.

In contrast, when the inter-terminal voltage of the second capacitor C2 is not in excess of the predetermined voltage (i.e., a sufficient amount of charge is not yet stored in the second capacitor C2), the microcontroller 600 remains in the power saving mode so that the charge storage operation in the second capacitor C2 is continued with no power consumed. As a result, data cannot be obtained in this period of time because the measurement, data processing, and wireless transmission operations are not performed.

Although in the present embodiment, the case in which two parallel capacitors, i.e., the first capacitor C1 and the second capacitor C2, are used is shown, a configuration in which three or more parallel capacitors are used is also possible. For example, with a configuration in which the first capacitor C1 is connected with the microcontroller 600, the second capacitor C2 is connected with the first switching circuit 800, the sensor 400, and the AD convertor 500 (C2>C1), and a third capacitor C3 is connected with a second switching circuit 801 and a wireless circuit 701 (C3>C2>C1), even if the charge storage operation in the third storage C3 is not completed, it is possible to operate the sensor 400 and the AD convertor 500 connected with the second capacitor C2 to perform measurements and store the measurement data in the memory included in the microcontroller 600 as long as the charge storage operation in the first capacitor C1 and the second capacitor C2 is completed. As a result, a period of time in which data cannot be obtained is unlikely to occur because the measurement data obtained while the amount of charge stored in the third capacitor C3 is insufficient can be wirelessly transmitted once the charge storage operation in the third capacitor C3 is completed

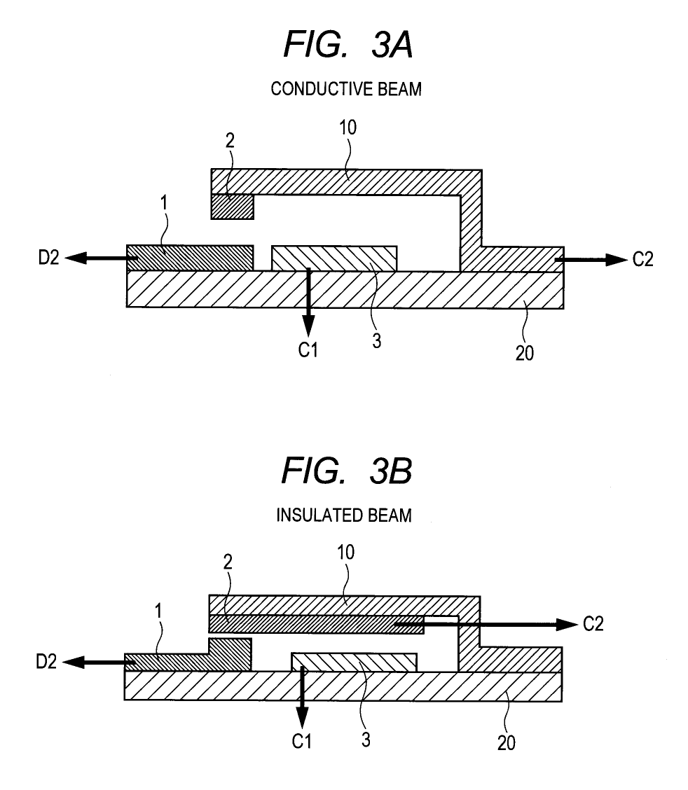

Although any element having the above described hysteresis property can be used as the selection element S1, by way of example, a configuration in which a three-terminal MEMS switch is used as the selection element S1 will now be described with reference to FIGS. 3A and 3B. MEMS switches shown in FIGS. 3A and 3B each include a movable part 10 disposed over a first electrode. FIG. 3A shows an MEMS switch having a movable part 10 made of a conductive material, while FIG. 3B shows an MEMS switch having a movable part 10 made of an insulating material. Using an MEMS switch as the selection element S1 can achieve the following advantages. That is, because MEMS switches turn on and off in a mechanical manner, no leakage current is generated, thus enabling the power consumption to be reduced to almost zero. In addition, in terms of RF characteristics, such as loss and isolation, MEMS switches may be superior to the existing MESFETs.

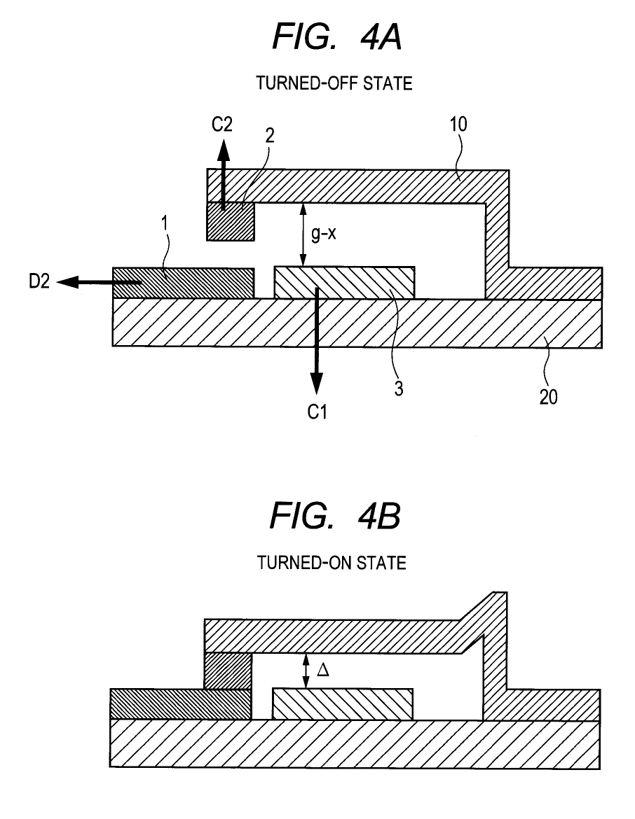

Referring to FIGS. 3A and 3B, MEMS switches having a three-terminal switch structure will be described. In FIGS. 3A and 3B, thick arrows denote electrical connections (this is also applicable to FIGS. 4A, 4B, and 6 described below). For example, FIG. 3A shows that a first electrode 1 is electrically connected with a diode D2, a second electrode 2 is electrically connected with a second capacitor C2, and a third electrode 3 is electrically connected with a first capacitor C1.

In FIG. 3A, a projection part is formed in a position on the surface of the movable part 10 made of a conductive material facing the first electrode 1; this projection part serves as the second electrode 2. The first electrode 1 is formed in a position on a substrate 20 facing the second electrode 2, i.e., the projection part. The third electrode 3, serving as the driving electrode, is disposed under the movable part 10 so that the switching operation is controlled on the basis of the potential difference between the second electrode 2 and the third electrode 3 (driving voltage V). Here, the second electrode 2 is formed as the projection part disposed on the tip of the movable part 10 so that the movable part 10 does not come into contact with the third electrode 3. The structure shown in FIG. 3A has an advantage in that wiring can be easily achieved because the movable part 10 itself can be used as a wiring component extending from the second electrode 2.

FIG. 3B shows an MEMS switch having a movable part 10 formed from an insulating material. First and third electrodes 1 and 3 are disposed on a substrate 20, and a second electrode 2 is formed in a position on the surface of the movable part 10 formed from an insulating material facing the first electrode 1 and the third electrode 3. As in FIG. 3A, the driving voltage V is used to control the switching operation so that the contact/non-contact state between the first electrode 1 and the second electrode 2 is controlled. FIG. 3B shows a structure in which the second electrode 2 does not come into contact with the third electrode 3 because a projection is formed on a portion of the first electrode 1 facing the second electrode 2.

FIGS. 4A and 4B are diagrams for describing the operating mechanism of an MEMS switch having the switch structure shown in FIG. 3A. FIG. 4A shows the turned-off state, while FIG. 4B shows the turned-on state. The first electrode 1 is connected with the second diode D2, the second electrode 2 is connected with the second capacitor C2 through the movable part 10, and the third electrode 3 is connected with the first capacitor C1. In the initial state of the MEMS switch shown, the second electrode 2 is at zero volts. Thereafter, as the charge supplied from the power generating element 300 is accumulated in the first capacitor C1, the driving voltage V, i.e., the potential difference between the second electrode 2 and the third electrode 3, is increased. While the driving voltage V is low, the movable part 10 may deform downward only by a small amount, thus not causing the switch to turn on. As the amount of charge stored in the first capacitor C1 increases, the driving voltage V gradually increases, thereby causing the movable part 10 to come closer to the third electrode 3 due to the Coulomb force, and when the second electrode 2 located on the tip comes into contact with the first electrode 1, the first electrode 1 and the second electrode 2 transition to the conductive state. The voltage at that time is referred to as the pull-in voltage Von. Once the first electrode 1 and the second electrode 2 transition to the conductive state, the potential difference between the first electrode 1 and the second electrode 2 immediately becomes zero, causing the driving voltage V to decrease. Here, having a hysteresis property in which the pull-in voltage Von is higher than the pull-out voltage Voff enables the MEMS switch to remain in the conductive state even after the driving voltage starts to decrease. As the driving voltage V decreases further, the Coulomb force attracting the second electrode 2 and the third electrode 3 to each other decreases, thereby allowing the second electrode 2 to come out of contact with the first electrode 1. As a result, the MEMS switch turns off, returning to the initial state. The driving voltage at that time is referred to as the pull-out voltage Voff.

In order to set the pull-in voltage Von, the rigidity of the movable part 10 needs to be adjusted by optimizing the length, the thickness, etc. of the movable part 10. Here, the pull-in voltage Von and the pull-out voltage Voff can be calculated using the following expressions.

$$Pull \text{-} in voltage \text{:} \\ {V}_{ON} = \sqrt{\frac{8}{27} \cdot \frac{{kg}^{3}}{{ɛ}_{0} S}} \\ Pull \text{-} out voltage \text{:} \\ {V}_{OFF} = \sqrt{\frac{2 k ( g - x ) {Δ}^{2}}{{ɛ}_{0} S}} \qquad Expression 1$$

In the expressions, k denotes the spring constant of the movable part, g denotes the gap spacing while the switch is in the turned-off state, ε₀ denotes the vacuum permittivity, S denotes the area of the third electrode 3, x denotes the displacement amount of the movable part while the switch is in operation, and Δ denotes the gap spacing while the switch is in the turned-on state. Therefore, using an MEMS switch as the selection element S1 enables the pull-in voltage Von and the pull-out voltage Voff to be set independently by selecting appropriate materials and designing the structure appropriately on the basis of the above expressions. As a result, the hysteresis property of the selection element S1 required for the sensing module 1000 can be designed.

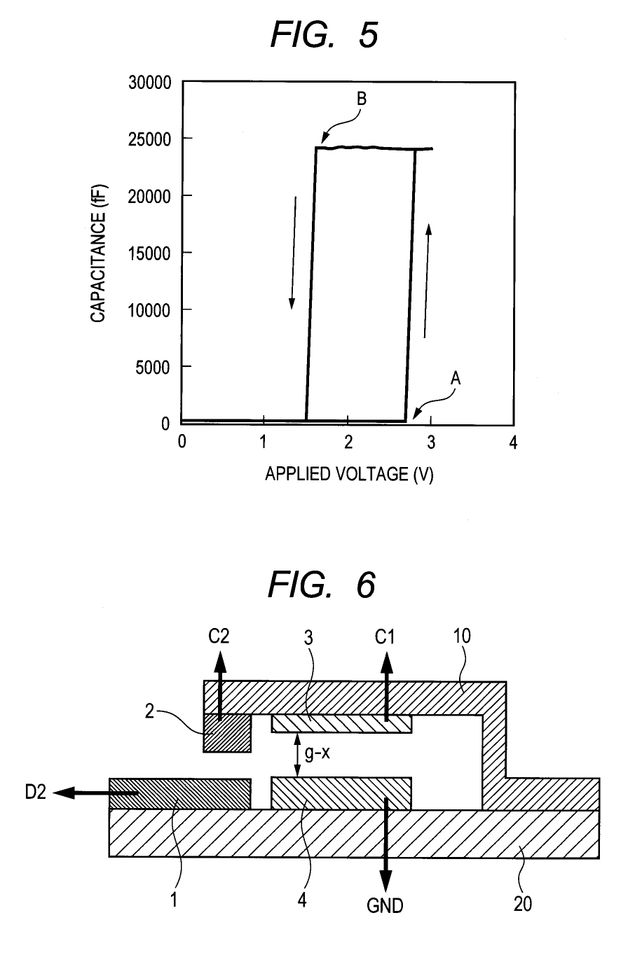

FIG. 5 shows an exemplary dependency upon the applied voltage when an MEMS switch is used as the selection element S1. The horizontal axis of the graph denotes the driving voltage V (the potential difference between the second electrode 2 and the third electrode 3), while the vertical axis denotes the capacitance formed between the second electrode 2 and the third electrode 3. Once the driving voltage V reaches about 2.7 V (the proximity of point A in FIG. 5), the movable part 10 is attracted to the third electrode 3, thereby bringing the second electrode 2 into to contact with the first electrode 1. This causes the first and second electrodes to transition to the conductive state. The voltage at point A is the pull-in voltage Von, which is 2.7 V in FIG. 5. Thereafter, as the driving voltage V decreases, the attracting force acting between the second electrode 2 and the third electrode 3 decreases, and when the driving voltage V reaches about 1.5 V (the proximity of point B in FIG. 5), the second electrode 2 comes out of contact with the first electrode 1. This causes the MEMS switch to turn off, resulting in the MEMS switch returning to the initial state. The voltage at point B is the pull-out voltage Voff, which is 1.5 V in FIG. 5. Therefore, this exemplary MEMS switch has a hysteresis property in which the pull-in voltage is 2.7 V and the pull-out voltage is 1.5 V.

As a result, even if, for example, the driving voltage V decreases to 2.2 V when the potential difference between the second electrode 2 and the third electrode 3 is reduced as the potential of the second electrode 2 increases because of the transition of the first electrode 1 and the second electrode 2 to the conductive state, the MEMS switch still can remain in the conductive state due to the hysteresis property. Therefore, the hysteresis property enables a length of time required to store a sufficient amount of charge in the second capacitor C2 to be secured by the time that the driving voltage V decreases to 1.5 V.

### Second Embodiment

A configuration in which a four-terminal MEMS switch is used as the selection switch S1 will now be described in connection with a second embodiment. Because the components other than the selection element S1 are the same as the first embodiment, a description thereof will be omitted.

FIG. 6 shows an exemplary four-terminal MEMS switch. On a semiconductor substrate 20, a first electrode 1 and a GND electrode 4 are disposed. The GND electrode 4 is connected to a fixed potential, i.e., the ground potential. Furthermore, a movable part 10 made of an insulating material is disposed over the first electrode 1 and the GND electrode 4. A second electrode 2 is formed in a position on the surface of the movable part facing the first electrode 1, while a third electrode 3 is formed in a position on the surface of the movable part facing the GND electrode 4. These four electrodes cooperate to enable the four-terminal MEMS switch to function.

Unlike the first embodiment, the third electrode 3 and the GND electrode 4 serve as the driving electrodes in the present embodiment. For this reason, in the present embodiment, the potential difference between the third electrode 3 and the GND electrode 4 serves as the “driving voltage V”, with which the switching operation is controlled. Therefore, in the present embodiment, any hysteresis property in which the potential difference between the third electrode and the fourth electrode when the first electrode and the second electrode transition from the non-conductive state to the conductive state is higher than the potential difference between the third electrode and the fourth electrode when the first electrode and the second electrode transition from the conductive state to the non-conductive state can be used. The advantages achieved by the hysteresis property in the present embodiment are the same as those achieved by the hysteresis property in the first embodiment.

Here, it is preferable that the film thickness of the second electrode 2 be higher than that of the third electrode 3 in order to achieve a structure in which the third electrode 3 does not come into contact with the GND electrode 4 when the MEMS switch turns on. Furthermore, when a four-terminal MEMS switch is used, the second electrode 2 and the third electrode 3 are formed on the movable part 10 separately. In order to allow these electrodes to have separate potentials, the movable part 10 is formed from an insulating material.

In the four-terminal MEMS switch, because the switching operation is performed using as the driving voltage V the potential difference between the third electrode 3 and the GND electrode 4 (having a fixed potential), even if the first electrode 1 and the second electrode 2 transition to the conductive state resulting in the same potential being applied to them, the potential of the GND electrode 4 does not increase. This enables the driving voltage V to be maintained. For this reason, it is possible to make the pull-out voltage Voff lower than that of the three-terminal MEMS switch described in the first embodiment. As a result, the four-terminal MEMS switch can remain in the conductive state for a longer length of time than the three-terminal MEMS switch, thus enabling the ability of the energy storage circuit 900 to store charge in the second capacitor C2 to be enhanced.

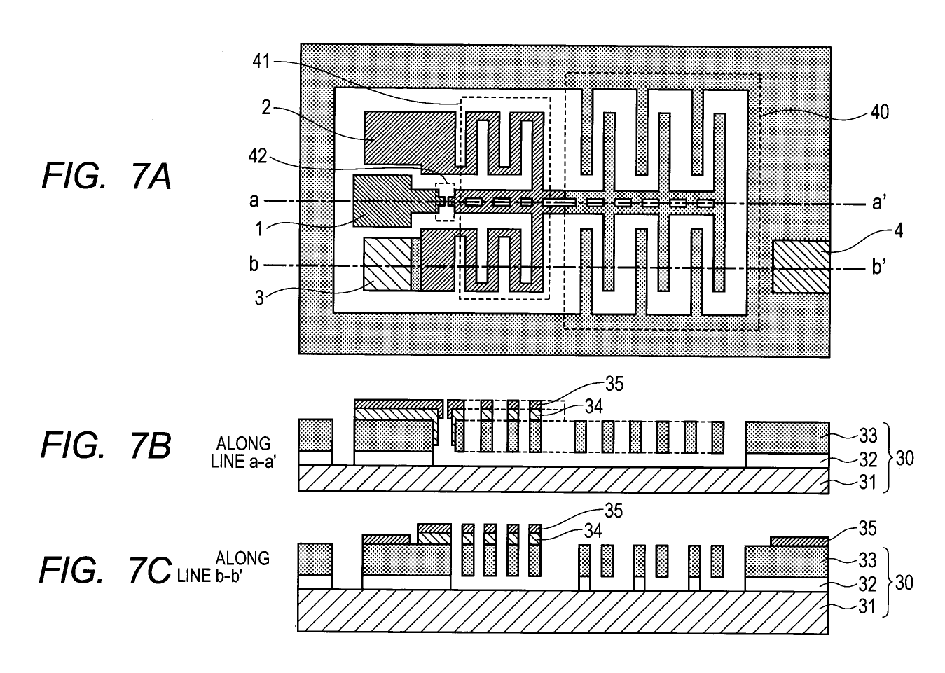

FIGS. 7A, 7B, and 7C show the configuration of another four-terminal MEMS switch that is applicable to the energy storage circuit 900. The four-terminal MEMS switch is formed on an SOI substrate so that the switch is driven in the horizontal direction. FIG. 7A is a top plan view, FIG. 7B is a sectional view taken along the line a-a′ in the top plan view, and FIG. 7C is a sectional view taken along the line b-b′ in the top plan view.

A third electrode 3 and a GND electrode 4 are formed directly on the SOI substrate 30, and the switching operation is controlled using the potential difference between the third electrode 3 and the GND electrode 4 via a device layer 33 of the SOI substrate 30. Here, a portion of the device layer 33 of the SOI substrate 30 connected with the third electrode 3 is electrically separated from a portion of the device layer 33 of the SOI substrate 30 connected with the GND electrode 4. Therefore, when the driving voltage V increases as the charge supplied from the power generating element 300 is accumulated in the first capacitor C1, a hollow portion connected with the third electrode 3 via the device layer 33 can move. As a result, a contact point 42 can transition between a contact state and a non-contact state by a switch spring member 41, thus resulting in the switching operation being achieved. First and second electrodes 1 and 2 are formed by processing an electrode film 35 formed on an insulating film 34 disposed on the SOI substrate 30, and are electrically separated from the device layer 33 of the SOI substrate 30, which is associated with the switching operation.

Again, in this four-terminal MEMS switch, which is formed on an SOI substrate and is driven in the horizontal direction, the switching operation is performed using as the driving voltage V the potential difference between the third electrode 3 and the GND electrode 4 (having a fixed potential). Therefore, the driving voltage V can be maintained even if the first electrode 1 and the second electrode 2 transition to the conductive state. As a result, the four-terminal MEMS switch can remain in the conductive state for a longer length of time than the three-terminal MEMS switch, thus enabling the ability of the energy storage circuit 900 to store charge in the second capacitor C2 to be enhanced.

What is claimed is:

1. An energy storage circuit, comprising:
a power generating element;
a first diode connected with the power generating element;
a first capacitor connected with the first diode;
a second diode connected with the power generating element; and
a selection element having a first electrode connected with the second diode, a second electrode connected with a second capacitor, and a third electrode connected with the first capacitor for controlling a conduction state between the first electrode and the second electrode, wherein a potential difference between the second electrode and the third electrode when the first electrode and the second electrode transition from a non-conductive state to a conductive state is higher than the potential difference between the second electrode and the third electrode when the first electrode and the second electrode transition from the conductive state to the non-conductive state.

2. The energy storage circuit according to claim 1, wherein the selection element includes an MEMS switch.

3. The energy storage circuit according to claim 2,
wherein the MEMS switch further includes a movable part disposed over the first electrode and made of a conductive material, and
wherein the second electrode is disposed in a position on a surface of the movable part, the position facing the first electrode.

4. The energy storage circuit according to claim 2,
wherein the MEMS switch further includes a movable part disposed over the first electrode and made of an insulating material, and
wherein the second electrode is disposed in a position on a surface of the movable part, the position facing the first electrode.

5. The energy storage circuit according to claim 1, further comprising:
a first terminal connected with the first capacitor; and
a second terminal connected with the second capacitor,
wherein the first terminal is connected with a circuit that consumes less power than a circuit connected with the second terminal.

6. The energy storage circuit according to claim 1, wherein the first capacitor is higher in capacitance than the second capacitor.

7. An energy storage circuit, comprising:
a power generating element;
a first diode connected with the power generating element;
a first capacitor connected with the first diode;
a second diode connected with the power generating element; and
a selection element having a first electrode connected with the second diode, a second electrode connected with a second capacitor, a third electrode connected with the first capacitor for controlling a conduction state between the first electrode and the second electrode, and a fourth electrode connected with a ground potential,
wherein a potential difference between the third electrode and the fourth electrode when the first electrode and the second electrode transition from a non-conductive state to a conductive state is higher than the potential difference between the third electrode and the fourth electrode when the first electrode and the second electrode transition from the conductive state to the non-conductive state.

8. The energy storage circuit according to claim 7, wherein the selection element includes an MEMS switch.

9. The energy storage circuit according to claim 8,
wherein the MEMS switch further includes a movable part disposed over the first electrode and the fourth electrode and made of an insulating material,
wherein the first electrode and the fourth electrode are disposed on a semiconductor substrate,
wherein the second electrode is disposed in a position on a surface of the movable part, the position facing the first electrode, and
wherein the third electrode is disposed in a position on the surface of the movable part, the position facing the fourth electrode.
